(19) United States
(12) Patent Application Publication
(10) Pub. No.: US 2018/0186337 A1
(43) Pub. Date: Jul. 5, 2018

(54) FRONT WIPER DEVICE FOR AUTOMOTIVE VEHICLE AND ASSEMBLY PROCESS

(71) Applicant: Valeo Systèmes d'Essuyage, Le Mesnil Saint Denis (FR)

(72) Inventors: François M. Broszniowski, Le Mesnil Saint Denis (FR); Frédéric Giraud, Le Mesnil Saint Denis (FR); Marcel Trebouet, Le Mesnil Saint Denis (FR)

(73) Assignee: Valeo Systèmes d'Essuyage, Le Mesnil Saint Denis (FR)

(21) Appl. No.: 15/858,448

(22) Filed: Dec. 29, 2017

(30) Foreign Application Priority Data
Jan. 2, 2017 (FR) 1750007

(51) Int. Cl. B60S 1/04; B60S 1/08; B60S 1/18; B60S 1/28

(52) U.S. Cl. CPC B60S 1/0447; B60S 1/28; B60S 1/18; B60S 1/08

(57) ABSTRACT

The subject of the invention is a windscreen-wiper device (1) for a front glazed panel of a motor vehicle, comprising at least one motor unit (2), drive means (4) and a support plate (10), said motor unit (2) comprising first fixing elements (12) capable of interacting with second fixing elements (13) provided in the support plate (10) so as to adopt a position of locking by insertion then rotation of a quarter turn about the axis Z of the drive shaft (3) of said motor unit (2).

The present invention relates to the field of windscreen-wiper devices for the glazed panels of a motor vehicle. The invention relates more particularly to a front windscreen-wiper device structure of a motor vehicle and the method for its assembly.

Windscreen-wiper devices for a rear glazed panel or front glazed panel of a motor vehicle are different. A rear windscreen-wiper device comprises a shaft for driving a single windscreen-wiper arm controlled and driven in rotation by an electric windscreen-wiper motor. A plate for supporting the motor unit and the drive shaft is fixed directly onto the internal face of the rear opening of the vehicle by means of a screw/nut assembly capable of immobilizing the windscreen-wiper device relative to the glazed panel, preferably by means of three fixing points.

Front windscreen-wiper devices, which are capable of supporting two windscreen-wiper arms, are more complex. Said arms are each disposed at the ends of a tubular structure or of a structure constituted by a support plate made from injection-moulded plastics, which structures are attached to the body of the vehicle. Said structures serve at one and the same time as support for the linkage capable of generating the movement of the windscreen-wiper arms by means of a simultaneous drive mechanism and as support for the control device of which the electric motor is part. In the case of a structure comprising a support plate, the motor unit is generally mounted on said fixing plate with three screws. This type of fixing by screwing is costly, requires a plurality of operations for fixing each screw and presents the risk of random reliability when the device is subject to the stresses and vibrations arising during functioning of the electric motor.

The object of the invention is to remedy the aforesaid drawbacks by proposing an alternative structure for a windscreen-wiper device for a front glazed panel of a motor vehicle, as part of which the windscreen-wiper motor is fastened to the support plate by means of resilient snap-fitting, particularly by means of complementary interaction of first fixing elements of the motor unit with second fixing elements provided in the support plate. A second object of the invention is to propose a method for assembly of said windscreen-wiper device comprising at least a step of positioning and a step of locking the motor unit to the support plate by means of a rotation movement. This structure without screwing ensures tight positioning of the motor unit on the support plate and improves the reliability of the device according to the invention.

A first subject of the invention is a windscreen-wiper device for a front glazed panel of a motor vehicle, comprising at least a motor unit comprising at least one casing, projecting from which there extends a drive shaft driven in rotation at the output from a motor housed in the casing, drive means configured in order to move two windscreen-wiper arms as a function of the rotation movement of the drive shaft, and a support plate configured in order to support, on the one hand, the motor unit and, on the other, rods for supporting a windscreen-wiper arm, the plate further comprising members for attachment to the body of the vehicle.

According to the invention, the motor unit and the support plate comprise fixing elements configured in order to interact by resilient snap-fitting through the effect of a relative rotation of the casing of the motor unit relative to the support plate.

According to different characteristics of the invention, taken alone or in combination, provision may be made as follows:
the device comprises first and second fixing elements, said first fixing elements being provided in the casing in order to interact with the second fixing elements provided in the support plate;
the first fixing elements of the motor unit are constituted by at least one element projecting from the casing and comprise a cylindrical portion that extends this casing and over the periphery of which extends a flange forming a cylindrical bumper. The flange forming the bumper may be made as a single component with the cylindrical portion or, alternatively, be produced separately and then sleeved on this cylindrical portion. Said first fixing elements are attached onto the casing of the motor unit by force-sleeving in cylindrical receiving stems;
the motor unit further comprises, on the face of the casing on which the first fixing elements are provided, a cylindrical stem of circular section for the guiding in rotation of its drive shaft about the axis Z. A complementary orifice serving for passing the axis through the plate is sufficiently broad to allow clearance between the axis and said cylindrical stem inside said complementary orifice. Preferably, the complementary orifice is of circular form and has a diameter at least equal to the exterior diameter of said cylindrical stem;
the second fixing elements provided on the support plate are constituted by at least one positioning orifice configured in order to interact with the at least one element projecting from the casing;
the at least one positioning orifice of said second fixing elements comprises two apertures of different dimensions, one emerging in the continuation of the other so as to form a continuous guide path with a direction of extension X and of a variable width along this direction of extension;
a first aperture of said positioning orifice has a width at least equal to the exterior diameter of the flange forming a bumper of the first fixing elements of the motor unit, said first aperture being extended by the second aperture that has a width smaller than the width of the first aperture but at least equal to the exterior diameter of the cylindrical portion of said first fixing elements;
the motor unit comprises at least three first fixing elements capable of being inserted, respectively, in a positioning orifice of the support plate;
the three first fixing elements are regularly distributed angularly about the drive shaft of the motor unit;
the support plate is constituted from plastics adapted to allow an interaction between the first and second fixing elements by deformation and resilient snap-fitting;
the support plate comprises a snap-fit element formed by a constriction portion between the first and the second aperture;
the support plate further comprises a snap-fitting element formed by a flexible blade. The flexible blade may be articulated on the support plate about an axis substantially parallel to the direction of the drive shaft and it may be articulated in order to interact by snap-fitting with a stop stud arranged so as to project from the casing of the motor unit;
the motor unit may comprise at least one cylindrical hollow stem capable of receiving a stop screw.

A second subject of the invention is a method for assembling a windscreen-wiper device for a front glazed panel of a motor vehicle according to the invention, comprising at least:
a step of insertion, by translation in a first direction, of the first fixing elements of the motor unit in the second fixing elements of the support plate,
a step of locking the fixing elements, by resilient snap-fitting, by relative rotation of the motor unit in relation to the plate, about an axis parallel to the first direction of translation.

According to an advantageous characteristic of the invention, the step of insertion takes place by translation in a direction parallel to the axis of the drive shaft.

In the course of this assembly method, at the time of the step of insertion by translation, the first fixing elements provided on the motor unit may be inserted in each first aperture of the second fixing elements of the support plate, and at the time of the locking step each first fixing element is able to interact with a second aperture of the second fixing elements of the support plate.

Furthermore, the step of locking may comprise the resilient snap-fitting of a resilient blade provided on the face of the plate facing the casing and a stop stud provided so as to project from the casing.

The assembly method may furthermore include an additional step of clamping the plate against the casing of the motor unit by means of a stop screw in a complementary stem arranged on the casing of the motor unit.

Other characteristics and advantages of the invention will become more clearly apparent on reading the detailed description of an embodiment of the invention given below by way of illustrative and non-limiting example and on the basis of the appended figures, which illustrate the windscreen-wiper device for a front glazed panel of a motor vehicle according to the invention, and amongst which:

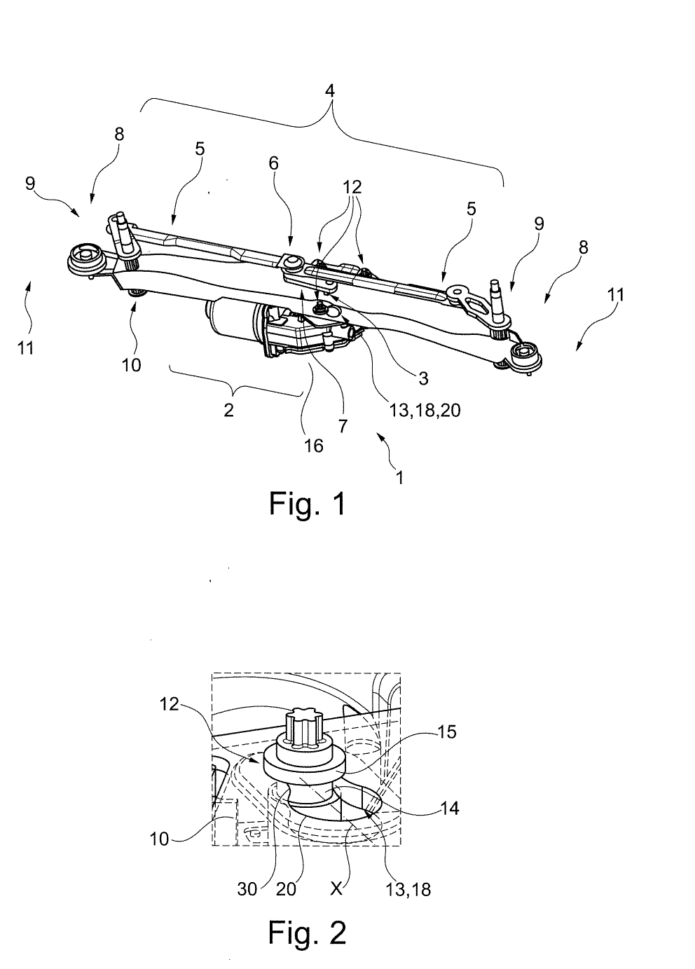

FIG. 1 is a perspective top view of the windscreen-wiper device according to an embodiment of the invention, showing, in particular, a motor unit fixed onto a support plate configured in order to support, furthermore, means for fixing to a structure of the vehicle and shafts for driving windscreen-wiper blades, not shown here;

FIG. 2 is a detailed perspective view of elements for fixing the motor unit onto the support plate, in particular a first fixing element provided in the motor unit interacting with a second fixing element provided in the support plate;

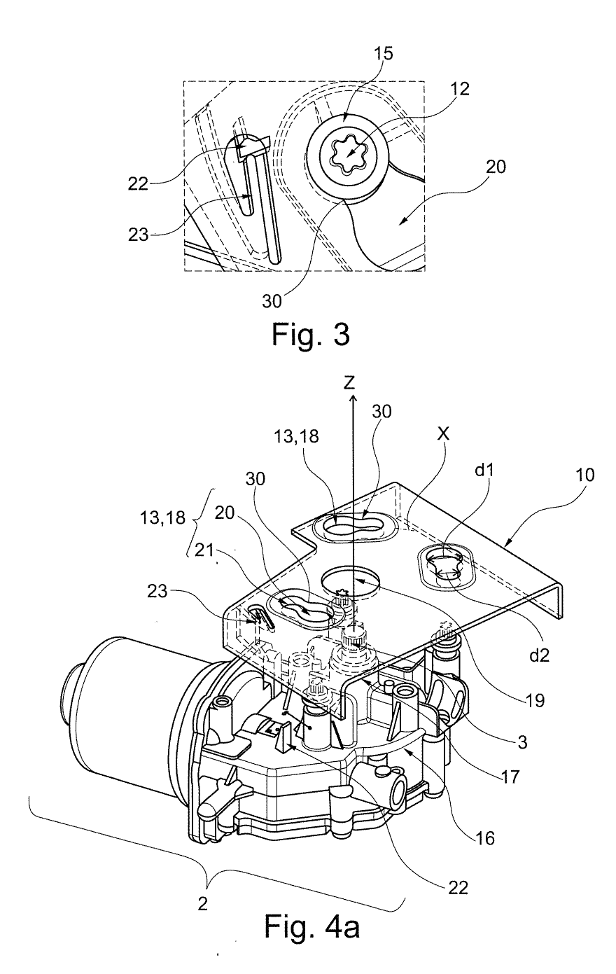

FIG. 3 is a top view of the fixing elements illustrated in FIG. 2, with additional elements involved in the resilient snap-fitting of the position of the motor unit relative to the support plate;

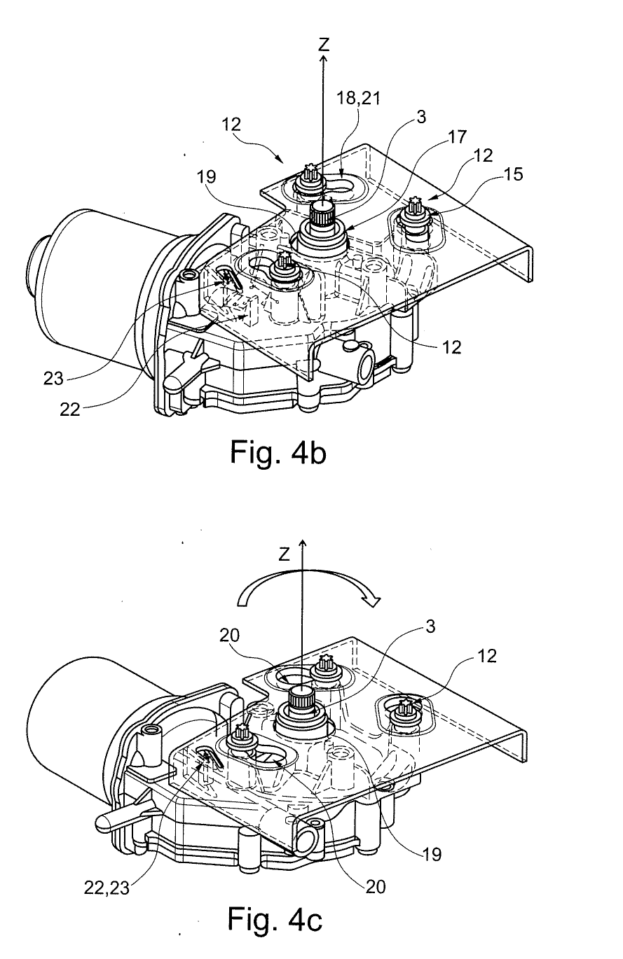

FIGS. 4a to 4c are perspective views of the arrangement according to the invention as part of which the casing of the motor unit carries first fixing elements capable of interacting with second fixing elements of the plate, said views presenting successive steps of assembly by insertion and locking of said means which are specific to the device according to the invention.

It should be noted that although the figures set out the invention in detail for its implementation, they may also be used to better define the invention as appropriate. It will also be understood that the embodiment of the invention illustrated by the figures is given by way of non-limiting example. As a result, other configurations of the device according to the invention may be implemented, in particular by variations in the arrangement, distribution and dimensioning of the first fixing elements of the motor unit and of the second fixing elements of the plate constituting the windscreen-wiper device according to the invention.

FIG. 1 illustrates the windscreen-wiper device 1 for a front glazed panel of a motor vehicle constituted essentially by a motor unit 2, a support plate 10 and drive means 4. The windscreen-wiper device 1 is presented as a whole, after arrangement of each structural element relative to one another, in particular after positioning and securing of the motor unit 2 on the support plate 10.

The motor unit 2 or control unit of the device 1, formed at least from an electric motor and, if appropriate, a gear motor, and also a drive shaft 3 and a hollow envelope of casing type 16, is capable of driving a con-rod/crank-type structure so as to convert the rotary movement of the electric motor into an alternating movement for the driver and passenger windscreen-wiper arms and blades.

The motor may be controlled in order to turn the drive shaft in one direction or the other so as to confer this rotation on the windscreen-wiper blades, in order that they will, in one or other direction, sweep over the glazed surface. The drive shaft 3 emerges from the casing on a fixing face 32 of the casing 16, this fixing face 32 of the casing being turned towards the support plate 10.

The drive means 4, or linkage, comprise two, driver and passenger, articulations 5 of longitudinal form connected to one another by their first end at a central junction point 6. A control con-rod 7 provides the connection between the junction point 6 and the drive shaft 3 of said motor unit 2.

The support plate 10, of substantially longitudinal form, is capable of supporting, on the one hand, at each end of its first “upper” face located opposite and parallel to the drive means 4, a support rod of a windscreen-wiper arm (not visible in this figure) and members 11 for attachment, driver and passenger anchoring points, to the body of the vehicle and, on the other hand, on its second “lower” face, the motor unit 2. Each support rod 8 is connected by a secondary con-rod 9 to each second free end of said driver and passenger articulations 5 so as to allow the movement of the windscreen-wiper arms.

The motor unit 2 is fixed to the plate 10 by interaction, by means of resilient snap-fitting, of first fixing elements 12 carried by the fixing face 32 of the casing 16 with second fixing elements 13 provided in the support plate 10. A description will be given below of an embodiment of said fixing elements in association with a method for mounting the motor on the support plate, said method proposing simplified mounting of said motor by means of two movements rather than by means of a multitude of movements involving fixings by screwing.

In this embodiment, the motor unit 2 comprises, on its casing 16 and more particularly on the fixing face 32, first fixing elements 12 capable of interacting with second fixing elements 13 provided in the support plate 10 so as to adopt a position of insertion by means of a first operation of translation in a direction parallel to the axis Z of the drive shaft 3 (referenced in FIGS. 4a to 4c), then a position of locking after relative rotation, for example by a quarter turn, of the motor unit 2 relative to the support plate, about said axis Z of the drive shaft 3.

FIGS. 2 and 3 illustrate, more particularly, the interaction of a first fixing element 12 of the motor unit 2 with a second fixing element 13 of the support plate 10.

At least one of the first fixing elements 12 is constituted by a cylindrical portion 14 that extends so as to project from the casing 16 of the motor unit and on the periphery of which there extends a flange 15 forming a cylindrical bumper. The first fixing elements 12 may be fixed on the casing 16 or attached thereto, by force-sleeving or by screwing, in cylindrical receiving stems 31 specifically provided for this purpose. In the example illustrated, the free end of the first fixing elements 12 is equipped with a six-branch screwing head to facilitate their placing in the receiving stems. Said flange 15 may, together with the cylindrical portion 14, constitute a single component or, alternatively, may be produced separately and then sleeved on said cylindrical portion.

At least one of the second fixing elements 13 provided on the support plate comprises a positioning orifice 18 configured in order to interact with a first fixing element 12. This positioning orifice 18 comprises two apertures of different dimensions that emerge in the continuation of one another, with a first aperture 20 that is configured and, in particular, dimensioned in order to allow a passage to a first fixing element and a second aperture 21 that is configured to retain this first fixing element. The fact that the first aperture emerges in the second aperture makes it possible to provide a continuous guiding path for the first fixing element 12 towards the second aperture in which it is retained by resilient snap-fitting. This continuous guiding path has a direction X of extension and a variable width along this direction of extension, thereby constituting, at the junction between the two apertures, a constriction portion 30 dimensioned in order to retain the first fixing element when the latter is retained in the second aperture 21 and resiliently deformable to allow a passage towards this second aperture through the effect of the relative rotation of the casing carrying the fixing elements in relation to the support plate carrying the positioning orifice.

It will be understood that the first aperture 20 has to have a width d1 at least equal to the exterior diameter of the flange 15 forming a bumper of the first fixing elements 12 of the motor unit in order to allow the passage of the bumper in the positioning orifice through the effect of a translation perpendicular to the plane of the support plate and that the second aperture 21 has to have a width d2, which is less than the width d1 of the first aperture, at least equal to the exterior diameter of the cylindrical portion 14 of these first fixing elements in order to accommodate the corresponding first fixing element after relative rotation of the motor unit in relation to the support plate.

In the example illustrated, the first aperture 20 is circular and has a diameter d1 greater, perpendicularly to the direction X of extension of the guiding path, than the width of the second aperture 21.

FIG. 3 illustrates in greater detail the position of irreversible locking of a first fixing element 12 in a second aperture 21 of a positioning orifice 18, said position being secured by interaction by means of snap-fitting of a flexible blade 23 articulated on the support plate about an axis substantially parallel to the direction of the drive shaft, about a stop stud 22, or locking attachment, arranged so as to project from the casing 16 of the motor unit. The flexible blade 23 is produced so as to project from the second face of the support plate, that is to say the face facing the casing 16 of the motor unit 2. The resilient nature of the flexible blade is obtained by cutting out from material in the thickness of the support plate 10.

As will be described in detail below, a first fixing element 12 is configured in order to be inserted into the second fixing element by means of a translation movement, then in order to be locked in a portion of the second fixing element through the effect of a relative rotation movement of the components carrying these fixing elements.

The flange 15, by means of its exterior diameter that is greater than that of the cylindrical portion 14, holds the first fixing elements 12 in the second fixing elements 13 after resilient snap-fitting of said first fixing elements in the positioning orifice 18, in particular in the second aperture 21. FIGS. 2 and 3 illustrate the final arrangement of said fixing elements 12 and 13, after insertion and locking of a first fixing element 12 in a positioning orifice 18 provided in the support plate 10.

FIGS. 4a to 4c illustrate the arrangement of the device according to the invention and also the successive steps of assembly of the structure. The embodiment illustrated in FIG. 4a shows, on the one hand, the casing 16 of the motor unit 2 carrying, at its fixing face 32, three first fixing elements 12, a drive shaft 3 arranged in a cylindrical stem 17 of circular section capable of guiding said drive shaft 3 in rotation about its axis Z and a locking attachment 22, and on the other hand shows the support plate 10 in which second fixing elements 13 and also a flexible blade 23 are arranged. The second fixing elements 13 of the support plate 10 are, here, constituted by three positioning orifices 18, each capable of receiving a first fixing element 12.

Moreover, the support plate 10 comprises a complementary orifice 19 capable of receiving the cylindrical stem 17 of the drive shaft 3.

The three first fixing elements 12, capable of being inserted, respectively, in one of the positioning orifices 18 of the support plate 10, are regularly distributed angularly about the drive shaft 3 of the motor unit 2, whilst the three second fixing elements 13 are regularly distributed about the complementary orifice 19. The spacing of these first and second fixing elements relative to the drive shaft and to the complementary orifice is such that when the support plate 10 and the motor unit 2 are superposed the first 12 and second 13 fixing elements correspond.

FIGS. 4a and 4b illustrate the insertion of the first fixing elements 12 in the second fixing elements 13, where each flange 15 is capable of interacting with each first aperture 20 of the positioning orifices 13 of the plate 10, by means of translation in a first direction parallel to the axis Z of the drive shaft 3, so as to adopt a position of insertion, illustrated in FIG. 4b. At the time of this movement of translation, the cylindrical stem 17 comprising the drive shaft 3 is simultaneously inserted into the complementary orifice 19 along the axis Z of said drive shaft 3, said complementary orifice 19 being sufficiently large to allow a passage for said cylindrical stem and to allow the relative rotation of the support plate and the motor unit.

FIG. 4c illustrates the position of locking the first fixing elements 12 in the second fixing elements 13 after relative rotation of the motor unit 2 in relation to the support plate, about said axis Z of the drive shaft 3, as represented by the arrow R. This relative rotation, which may, in particular, be achieved by rotation of the motor unit 2 about said axis Z relative to a fixed support plate, allows the displacement of each cylindrical portion 14 of the first fixing elements 12 in each second aperture 21 of the positioning orifices 18 of the support plate 10, forcing the passage of the constriction portion 30. The reduction in section of the guiding path in this constriction portion makes it possible thereafter to hold the cylindrical portion in the second aperture, in combination with the presence of the flange 15 forming the bumper which prevents the first fixing elements 12 from escaping from the second aperture 21 in a direction perpendicular to the plane in which the relative rotation movement is inscribed.

The relative rotation of the casing 16 of the motor unit 2 relative to the support plate 10 simultaneously ensures the interaction of a stop stud 22 arranged so as to project from the casing 16 with the flexible blade 23 formed in the support plate.

According to a particular characteristic of the invention, the aim is for the second fixing elements to be oriented such that the stresses generated by the rotation of the electric motor in the course of the functioning of the windscreen-wiper device tend to push the first fixing elements towards the bottom of the second apertures 21 of the positioning orifices 18. Thus, the second fixing elements are arranged such that the second apertures extend the first apertures by being arranged after these first apertures in the direction of rotation of the electric motor.

The support plate 10 is constituted from plastics, the resilient properties of which allow a deformation of the snap-fit elements defined by the constriction portion 30 between the two apertures and by the flexible blade 23, and a resilient snap-fitting of these elements with, respectively, the first fixing elements and the stop 22.

More precisely, the constriction portion 30 can be deformed such that, at the time of the relative rotation of the motor unit 2 in relation to the support plate, this constriction portion is able to enlarge in order to allow a passage for the cylindrical portion 14 towards the second aperture 21 through the effect of a sufficient automated or manual pressure effort, it being understood that the constriction portion is resilient in order to resume its original form after passage of the cylindrical portion and in order thus to block the first fixing elements 12 in an irreversible locking position.

The flexible blade 23, meanwhile, is capable of withdrawing, at the time of the relative rotation of the motor unit 2 in relation to the support plate, on contact with the stop 22 which is arranged on the casing in order to be located on the path of the flexible blade. The resilient nature of the flexible blade 23 enables the latter to move aside on contact with the stop in order to allow the rotation to finish, then to resume its original position at the end of said rotation in order to come into contact with the rear face of said stop and to prevent any rotation in the opposite direction.

In a variant embodiment (not illustrated) of a device according to the invention, the position of locking is secured, further, by clamping of a stop screw in a hollow cylindrical stem located on the casing 16 of the motor unit 2. Said cylindrical stem/stop screw system may be positioned, for example, in the vicinity of the cylindrical stem 17 comprising the drive shaft 3 of the motor unit 2.

A description will now be given of an implementation of the method for assembly of the windscreen-wiper device 1 for a front glazed panel of a motor vehicle. This method comprises, in particular, a step of insertion of the first fixing elements of the motor unit in the second fixing elements of the support plate and a step of locking these elements.

The step of insertion, illustrated in FIGS. 4a and 4b, is achieved by a translation, in a first direction, of the first fixing elements 12 of the motor unit 2 in the second fixing elements 13 of the support plate 10. As described above, this translation may advantageously be performed in a direction parallel to the axis Z of the drive shaft 3. In this step of insertion, the angular position of the motor unit relative to the support plate is adjusted such that the first fixing elements 12 provided on the motor unit 2 are inserted in each first aperture 20 of the second fixing elements 13 of the support plate.

The last step of locking, illustrated in FIG. 4c, is achieved by a relative rotation of the motor unit in relation to the plate, about an axis parallel to the first direction of translation, so that each first fixing element 12 interacts with a second aperture 21 of the second fixing elements 13 of the support plate. The step of locking consists, in particular, in the fixing elements being resiliently snap-fitted together by means, in particular, of a constriction portion 30. Provision may also be made for an additional snap-fitting to be achieved at the end of relative rotation of the motor unit in relation to the plate, particularly by means of interaction of the flexible blade 23 provided on the face of the plate facing the casing 16 and the stop stud 22 provided so as to project from the casing.

The assembly method may further comprise an additional step (not illustrated) of clamping the plate against the casing of the motor unit by means of the stop screw in the complementary stem arranged on the casing 16 of the motor unit 2.

The above description clearly explains how the invention makes it possible to achieve the objects set and, in particular, to propose an alternative structure for a windscreen-wiper device for a front glazed panel of a motor vehicle, which, by means of an arrangement and an interaction of the first fixing elements of the motor unit with second fixing elements of the support plate constituting resilient snap-fit means makes it possible to increase the reliability of said device by holding it in an irreversible locked position. The present invention is not limited to the embodiments given by way of non-limiting examples.

1. A windscreen-wiper device for a front glazed panel of a motor vehicle, comprising:
a motor unit comprising at least one casing, projecting from which there extends a drive shaft driven in rotation at the output from a motor housed in the casing,
drive means configured to move two windscreen-wiper arms as a function of the rotation movement of the drive shaft,
a support plate configured to support the motor unit and rods for supporting a windscreen-wiper arm, the plate further comprising members for attachment to the body of the vehicle,
wherein said motor unit and the support plate comprise fixing elements configured to interact by resilient snap-fitting through the effect of a relative rotation of the casing of the motor unit relative to the support plate.

2. The device according to claim 1, further comprising first and second fixing elements, said first fixing elements being provided in the casing to interact with the second fixing elements provided in the support plate.

3. The device according to claim 2, wherein the first fixing elements of the motor unit are constituted by at least one element projecting from the casing and comprising a cylindrical portion that extends this casing and over the periphery of which extends a flange forming a cylindrical bumper.

4. The device according to claim 2, wherein the second fixing elements provided on the support plate are constituted by at least one positioning orifice configured to interact with the at least one element projecting from the casing.

5. The device according to claim 4, wherein the positioning orifice comprises two apertures of different dimensions, one emerging in the continuation of the other so as to form a continuous guide path with a direction of extension and of a variable width along the direction of extension.

6. The device according to claim 5, wherein a first aperture has a width at least equal to the exterior diameter of the flange forming a bumper of the first fixing elements of the motor unit, said first aperture being extended by the second aperture that has a width smaller than the width of the first aperture but at least equal to the exterior diameter of the cylindrical portion of said first fixing elements.

7. The device according to claim 2, wherein the motor unit comprises at least three first fixing elements capable of being inserted, respectively, in a positioning orifice of the support plate, the three first fixing elements being regularly distributed angularly about the drive shaft of the motor unit.

8. The device according to claim 5, wherein the support plate is constituted from plastics.

9. The device according to claim 8, wherein the support plate comprises a snap-fit element formed by a constriction portion between the first and the second aperture.

10. The device according to claim 8, wherein the support plate comprises a snap-fit element formed by a flexible blade, the flexible blade being articulated to interact by snap-fitting with a stop stud arranged to project from the casing of the motor unit.

11. A method for assembling a windscreen-wiper device for a front glazed panel of a motor vehicle according to claim 1, comprising:
insertion, by translation in a first direction, of the first fixing elements of the motor unit in the second fixing elements of the support plate; and
locking the fixing elements, by resilient snap-fitting, by relative rotation of the motor unit in relation to the plate, about an axis parallel to the first direction of translation.

12. The method according to claim 11, wherein insertion takes place by translation in a direction parallel to the axis Z of the drive shaft.

13. The method according to claim 12, wherein the second fixing elements are constituted by at least one positioning orifice comprising a first aperture, and wherein, at the time of the insertion by translation, the first fixing elements provided on the motor unit are inserted in each first aperture of the second fixing elements of the support plate, and wherein the locking comprises the interaction of each first fixing element with a second aperture of the second fixing elements of the support plate.

14. The method according to claim 11, wherein the step of locking further comprises the resilient snap-fitting of a flexible blade provided on the face of the plate facing the casing and of a stop stud provided so as to project from the casing.

15. The method according to claim 11, further comprising clamping the plate against the casing of the motor unit by a stop screw in a complementary stem arranged on the casing of the motor unit.
